(19) United States
(12) Patent Application Publication
(10) Pub. No.: US 2019/0312940 A1
(43) Pub. Date: Oct. 10, 2019

(54) Apparatus and method for analyzing using pattern of crypto currency and providing service based on artificial intelligence

(71) Applicant: COINTOSS Co., Ltd, Seoul (KR)

(72) Inventor: Gi Hong Yang, lncheon (KR)

(21) Appl. No.: 15/962,003

(22) Filed: Apr. 25, 2018

(30) Foreign Application Priority Data
Apr. 5, 2018 (KR) 10-2018-0039486

(51) Int. Cl. H04L 29/08; G06Q 20/06; G06F 17/30; H04L 9/06; G06K 9/62; G06F 17/27; G06N 3/04

(52) U.S. Cl. CPC H04L 67/22; G06Q 20/06; G06F 17/30185; G06N 3/0454; G06K 9/6223; G06F 17/2755; H04L 9/0637

(57) ABSTRACT

An apparatus and a method for analyzing a using pattern of crypto currency and providing a service based on artificial intelligence are provided. The apparatus analyzes a using pattern of artificial intelligence-based crypto currency and provides customized services by analyzing a using pattern of a user who uses crypto currency in response to popularization of the crypto currency. The apparatus predicts a future using pattern of the user by analyzing the using pattern of the user only with simple using of the crypto currency, provides various customized services to respective users through analysis and prediction of using patterns by artificial intelligence, maximizes usage convenience by handling processes from the use of crypto currency to the providing of service as one stop, and maximizes precision of using pattern analysis and satisfaction of service provided to the user by combining characteristics of crypto currency and advantages of artificial intelligence.

### CROSS-REFERENCE TO RELATED APPLICATION

This application claims priority to and the benefit of Korean Patent Application No. 10-2018-0039486 filed in the Korean Intellectual Property Office on Apr. 5, 2018, the entire contents of which are incorporated herein by reference.

### BACKGROUND OF THE INVENTION

### (a) Field of the Invention

The present invention relates to an apparatus and a method for analyzing a using pattern of crypto currency and providing a service based on artificial intelligence. In recent years, in addition to commodity money issued by the existing central bank, crypto currency which can be used in a certain network because they are encrypted by a technology such as a block chain and distributed without being issued by a public institution such as a central bank, is increasingly popularized.

The crypto currency exists in a digital way instead of existing as a real object such as a coin or a banknote like commodity money and circulates through a network, and thus is different from existing commodity money in an existence mode and a payment mode. However, since it circulates through the network, it is possible to collect usage history thereof. The present invention relates to an apparatus and a method for analyzing a using pattern of artificial intelligence-based crypto currency on the basis of this collecting characteristic and providing various services to users through the analyzed result.

### (b) Description of the Related Art

Money is a common distribution means, indicating a value of things. As a means of mediating the exchange of goods, shells of shellfishes and leather of animals were used in ancient times, and then precious metals such as gold and silver were used as means of distribution. Currently, coins made of a metal and banknotes made of special paper which are given certain amounts of value are commonly used.

The history of these currencies has evolved from natural money into metal money such as gold and silver, and is now developing into an abstract concept of credit money. In recent years, a concept of digital money which is used by converting such spot money into the digital money has emerged, rather than trading in spot money such as coins and banknotes.

The digital money may be said to be converted into a form transformed in a more convenient way under the base of spot currency rather than different from the spot money strictly. Specifically, the digital money is a form that is used or distributed through a network by converting monetary value into digital information, encrypting it, storing it in an IC guard, and carrying it.

All the credit money and digital money mentioned above are meaningful under the gold standard system. The central bank of each country keeps gold as much as the amount of currency issued, and general banks comply with the cash reserve ratio and supply more money than the currency issued on the market to facilitate the circulation of money.

All of these currencies are basically based on real things, but the recent spread of crypto currency is accelerating. Such crypto currency is not issued by the central bank but is issued by a developer. In addition, the crypto currency, which is an encrypted digital money unlike commodity money, is dispersed and stored in a P2P manner through a network and is distributed through the network and operated and managed. Accordingly, the crypto currency has a feature in which all information generated in a situation where an owner is changed is shared by the network.

Conventionally, a system that analyzes consumption patterns of users in a process of using commodity money and uses the analyzed result to execute marketing and to provide appropriate services to the users.

Patent Publication No. 2015-0090376 discloses a consumption pattern-based marketing service providing system that analyzes consumption patterns generated from card payment information and generates analysis information including a target product to be marketed and a target consumption pattern, and then generates promotion information such as mobile discount information based on the analysis information and provides the promotion information to users.

However, since the marketing service providing system disclosed in Patent Publication No. 2015-0090376 collects card payment information to analyze consumption patterns, in the case of using cash, the consumption pattern analysis cannot be performed. In addition, since it is performed based on the use of cards, the consumption pattern analysis is limited and inaccurate.

Patent Publication No. 2014-0003813 discloses a targeting advertisement apparatus based on a user payment pattern, which generates consumption pattern data of users by analyzing stamp information issued at franchises used by users and generates a mission-based advertisement that can induce user's participation by using the generated consumption pattern data to provide a reward item to the users who participate in the mission.

However, the targeting advertisement apparatus disclosed in Patent Publication No. 2014-0003813 is based on the use of the card similarly to the aforementioned marketing service providing system and has problems that the consumption pattern analysis is limited and inaccurate and that a service provided to a device that uses the consumption pattern analysis result as an advisement is fragmentary.

Conventional consumption pattern analysis and marketing apparatuses including the apparatuses disclosed in the above-mentioned prior art documents analyzes consumption patterns of users based on limited data, and thus the accuracy of the analysis is poor. In addition, the service provided depending on the analysis results is limited to marketing, advertisement, etc., and the service provided is not diversified and active service may not be provided. Besides, it is not applicable to the crypto currency which that has recently been popularized.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention, which is contrived to solve the aforementioned problems, provides an apparatus for analyzing a using pattern of artificial intelligence-based crypto currency and providing a service, capable of providing customized services by analyzing a using pattern of a user who uses crypto currency in response to popularization of the crypto currency, predicting a future using pattern of the user by analyzing the using pattern of the user only with simple using of the crypto currency, providing various customized services to respective users through analysis and prediction of using patterns by artificial intelligence, maximizing usage convenience by handling processes from the use of crypto currency to the providing of service as one stop, and maximizing precision of using pattern analysis and satisfaction of service provided to the user by combining characteristics of crypto currency and advantages of artificial intelligence.

To solve the above problems, an aspect of the present invention features an apparatus for analyzing a using pattern of artificial intelligence-based crypto currency and providing a service, including: a usage history collecting module configured to collect a history of using the crypto currency by a user who owns the crypto currency; a data base configured to store data necessary for analyzing crypto currency using pattern and providing services, including data related to users who own crypto currencies, the collected using history, and data related to services to be provided; a pattern analyzing and predicting module configured to analyze a using pattern of the user and predict a future using pattern based on the data stored in the data base and artificial intelligence; and a service providing module configured to provide a service based on the using patterns of the user analyzed and predicted in the pattern analyzing and predicting module.

The crypto currency may be a crypto currency based on a block chain technique, and the usage history collecting module may collect information necessary for using pattern analysis from usage information of the crypto currency transferred in real time based on the block chain technique.

The collected using history may include information related to a user who uses the crypto currency, an object for which the crypto currency, a time at which the crypto currency is used, and an amount of the used crypto currency, and the pattern analyzing and predicting module may match and combine additional information of the user stored in the data base with the collected using history, and then may analyze the using pattern based on the combined data and predicts a future using pattern.

The analysis and the prediction of the using patterns based on the combined data by the pattern analyzing and predicting module may be performed through an artificial-intelligence algorithm, and the artificial-intelligence algorithm may be improved by learning with the data matched and combined with the additional information stored in the data base to improve precision of the analysis and prediction of the using patterns whenever using history is added through the usage history collecting module.

The pattern analyzing and predicting module may cluster the data stored in the data base through an unsupervised learning process including a k-means algorithm among machine learning, and then may analyze a using pattern of the collected using history based on the clustered data through an artificial-intelligence algorithm and predicts a future using pattern.

The service providing module may determine a service object to be provided based on the using patterns analyzed and predicted in the pattern analyzing and predicting module, and the determination of the service object may be performed through a sensitivity analysis that performs analysis by quantifying SNS data related with the service object and evaluation information of the service object.

The sensitivity analysis may be performed based on a set of data obtained by quantifying SNS data related to a service object which is textual data and evaluation information related to the service object through a natural language processing and a set of data quantified through evaluation for quantifying a qualitative object including Likert scale related to a specific word or clause.

Data input or output may be performed through an open platform that is to be provided through an API in the apparatus for analyzing a using pattern of artificial intelligence-based crypto currency and providing a service, including the usage history collecting module and the service providing module.

When a field of a service to be provided by the service providing module relates to travel, the pattern analyzing and predicting module may use an artificial-intelligence algorithm obtained by a combination of a convolutional neural network and a recursive neural network to analyze and predict a using pattern of a user.

The service providing module may provide a service to a user in consideration of a moving route of the user by using data related to a usage position of the using history collected in the usage history collecting module.

Another aspect of the present invention features a method for analyzing a using pattern of artificial intelligence-based crypto currency and providing a service, including: collecting a history of using the crypto currency by a user who owns the crypto currency through a usage history collecting module; storing the using history of the user collected whenever the using history is collected, in a data base, and pre-storing data necessary for analyzing crypto currency using pattern and providing services, including data related to users who own crypto currencies, the collected using history, and data related to services to be provided, in the data base; analyzing a using pattern of the user and predict a future using pattern based on the data stored in the data base and artificial intelligence in a pattern analyzing and predicting module; and providing a service to the user by a service providing module based on the using pattern of the user and the future using pattern analyzed and predicted in the analyzing of the using pattern and the predicting.

The crypto currency may be a crypto currency based on a block chain technique, and information necessary for using pattern analysis may be collected from usage information of the crypto currency transferred in real time based on the block chain technique in the collecting of the using history.

The collected using history may include information related to a user who uses the crypto currency, an object for which the crypto currency, a time at which the crypto currency is used, and an amount of the used crypto currency, the analyzing of the using pattern and the predicting may further include matching and combining additional information of the user stored in the data base with the collected using history, and the using pattern may be analyzed based on the combined data to predict a future using pattern.

The analysis and the prediction of the using patterns based on the combined data may be performed through an artificial-intelligence algorithm in the analyzing of the using pattern and the predicting, and the artificial-intelligence algorithm may be improved by learning with the data matched and combined with the additional information stored in the data base to improve precision of the analysis and prediction of the using patterns whenever using history is added in the collecting of the usage history.

The analyzing of the using pattern and the predicting may further include unsupervised learning including a k-means algorithm of machine learning for the data stored in the data base, and the data stored in the data base may be clustered through the unsupervised learning, and then a using pattern of the collected using history may be analyzed based on the clustered data through an artificial-intelligence algorithm to predict a future using pattern.

The providing of the service may include determining a service object to be provided based on the using patterns analyzed and predicted in the analyzing of the using pattern and the predicting, and the determination of the service object may be performed through a sensitivity analysis that performs analysis by quantifying SNS data related with the service object and evaluation information of the service object.

The sensitivity analysis may be performed based on a set of data obtained by quantifying SNS data related to a service object which is textual data and evaluation information related to the service object through a natural language processing and a set of data quantified through evaluation for quantifying a qualitative object including Likert scale related to a specific word or clause.

Data input or output may be performed through an open platform that is to be provided through an API in the method for analyzing a using pattern of artificial intelligence-based crypto currency and providing a service, including the collecting of the using history and the providing of the service.

When a field of a service to be provided in the providing of the service relates to travel, an artificial-intelligence algorithm that is used in the analyzing of the using pattern and the predicting may be obtained by a combination of a convolutional neural network and a recursive neural network to analyze and predict a using pattern of a user.

The providing of the service may include providing a service to a user in consideration of a moving route of the user by using data related to a usage position of the using history collected in the collecting of the using history.

According to the exemplary embodiments of the present invention, it is possible to provide customized services to users by analyzing using patterns of crypto currencies.

In addition, even when the crypto currencies are simply used, it is possible to predict future using patterns of the users by analyzing using patterns of the users.

It is possible to accurately analyze using patterns of various users by applying artificial intelligence to analysis of using patterns and prediction of future using patterns, thereby maximizing satisfaction of services provided.

Furthermore, only with simple use of crypto currency, customized services can be provided to users by combining characteristics of crypto currency and advantages of artificial intelligence, and processes from the use of crypto currency to the providing of service can be handled as one stop to maximize usage convenience.

### BRIEF DESCRIPTION OF THE DRAWINGS

FIG. 1 is a schematic block diagram illustrating an apparatus for analyzing a using pattern of artificial intelligence-based crypto currency and providing a service according to an exemplary embodiment of the present invention.

FIG. 2 illustrates an example of an analysis process according to an emotion analysis of the present invention.

FIG. 3A and FIG. 3B respectively illustrate examples of a convolutional neural network (CNN) and a recursive neural network (RNN) in an artificial-intelligence algorithm.

FIG. 4 is a flowchart illustrating a method for analyzing an artificial intelligence-based crypto currency using pattern and providing a service according to an exemplary embodiment of the present invention.

### DETAILED DESCRIPTION OF THE EMBODIMENTS

An apparatus for analyzing a using pattern of artificial intelligence-based crypto currency and providing a service will be described with reference to the accompanying drawings.

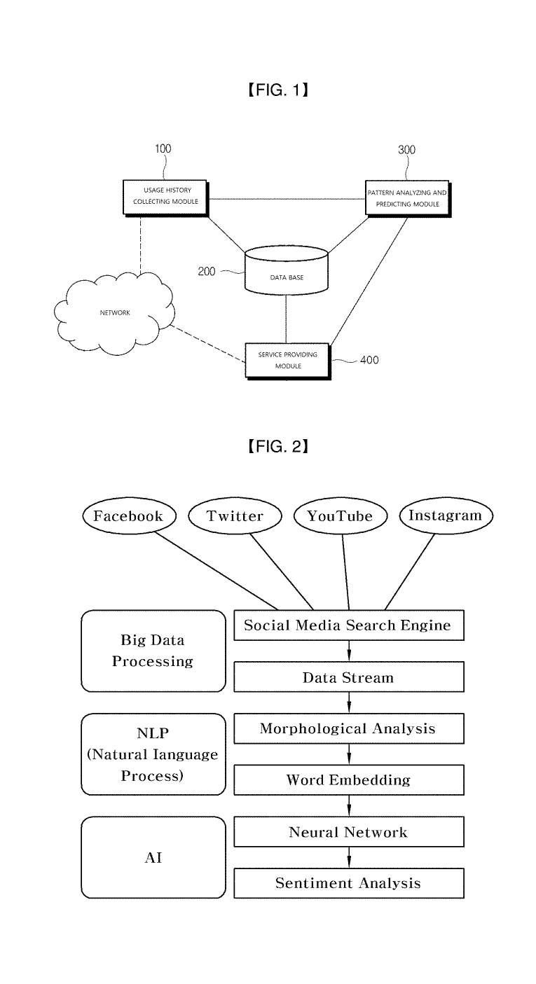

FIG. 1 is a schematic block diagram illustrating an apparatus for analyzing a using pattern of artificial intelligence-based crypto currency and providing a service according to an exemplary embodiment of the present invention.

According to the present exemplary embodiment, the apparatus for analyzing the using pattern of artificial intelligence-based crypto currency and providing the service (using pattern analyzing and service providing apparatus) relates to an apparatus that corrects usage history of a user who owns crypto currency that has been widely popularized in recent years when the user uses the crypto currency, analyzes it through an artificial-intelligence algorithm, and provides customized services. In the present exemplary embodiment, the using pattern analyzing and service providing apparatus provides various user-customized services by analyzing a using pattern of a user with usage history of simply using crypto currency by the user based on an artificial-intelligence algorithm that can positively utilize an advantage of an operating management using a network which is a characteristic of the crypto currency different from commodity money and can efficiently perform multi-dimensional analysis, and by predicting a future using pattern.

In the present exemplary embodiment, a usage history collecting module 100 is configured to collect history of using crypto currency by a user who owns the crypto currency, such as purchasing an article or paying for a service.

As described above, crypto currency which is digital data, is encrypted through a cryptographic technique including a public key encryption system and is distributed, stored, and operated to a user connected by a network by using a same technique as a block chain. Basically, the crypto currency is different from commodity money in that it is operated and managed by a network or a device connected with the network, and operation methods thereof are different in that the crypto currency is distributed in a P2P method to be managed instead of being controlled centrally.

In the case of commodity money, it is very difficult to collect usage history unless users record the usage history or use credit cards that require transaction approval procedures, and even when a credit card is used, collection of usage history is limited, and thus it is difficult to accurately grasp using patterns of the users.

In contrast, the crypto currency is basically operated in a network, and all transactions is required to be reflected in real-time to users to be stored in the network. Accordingly, the crypto currency can grasp all the usage history of users and can accurately grasp using patterns of the users.

A block-chain technique applied to operation and management of crypto currency is one of distributed data base techniques as a technique applied to a book that records transaction history of crypto currency. A P2P network of crypto-currency users connected by Internet is configured, and transaction history of a block unit is stored in a device such as a user's PC connected to the network.

Since crypto currency needs to be distributed to be devices of all users therein by block chain to be therein, data capacity thereof is small, and basically since transaction data of a linked list structure is divided into blocks in a light-weight file DB such as a level DB, and thus it cannot be arbitrarily modified by anyone, so data forgery/alteration is very difficult.

In the present exemplary embodiment, the usage history collecting module 100 collects a user who uses crypto currency that is essentially included in data distributed and stored in real time when a transaction occurs by the block chain described above, an object for which the crypto currency is used, a time at which the crypto currency is used, and an amount of the used crypto currency. Such information is necessarily transferred to an owner of the crypto currency in a network in all transactions. Accordingly, in the present exemplary embodiment, the using pattern analyzing and service providing apparatus needs to be connected to the network, and the usage history collecting module 100 collects the above information and then stores it in the data base 200.

In the present exemplary embodiment, a data base 200 is configured to store all information that is necessary for using pattern analysis and prediction of a future using pattern and a service provided to a user in the using pattern analyzing and service providing apparatus.

The crypto currency is normally issued through a proof of work and a proof of stake. Additional information including personal information of the user may be obtained in the issuing process and may also be stored in the data base 200 in the present exemplary embodiment. In addition, all information required to analyzing and predicting using patterns and providing services, including information related to partner companies in which the crypto currency is available as a mode of payment, information related to services to be provided, information related to an artificial-intelligence algorithm, data set required for sensitivity analysis, etc. is stored in the data base 200.

In the present exemplary embodiment, a pattern analyzing and predicting module 300 is configured to analyze a using pattern of a user to predict a future using pattern by using usage history collected in the usage history collecting module 100 and data and the artificial-intelligence algorithm stored in the data base 200.

A most important information for analyzing a user using pattern and predicting a future using pattern is usage history collected in the usage history collecting module 100. Although analysis and prediction of using patterns can be performed by using the collected usage history only, additional information related to users is required for more accurate analysis and prediction. Specifically, information related to personal data such as age, sex, and address and an economic status such as occupation and income is obtained in advance with agreement and then is stored in the data base 200, and is combined with the additional information via information related to users among the collected usage history. The pattern analyzing and predicting module 300 analyzes a using pattern and predicts a future using pattern through an artificial-intelligence algorithm based on the combined data in order to improve accuracy and precision of the analysis and the prediction. In addition, the artificial-intelligence algorithm is learned through new data whenever new usage history is collected and is combined with the additional information, or for a period of time. A process in which the artificial-intelligence algorithm is learned is a procedure of adjusting the coefficients of a formula included in the algorithm by analyzing results after inputting new data. This process can further improve the accuracy of analysis and prediction of usage patterns.

In the artificial-intelligence algorithm, machine learning is roughly classified into supervised learning and unsupervised learning. In the supervised learning analysis and prediction may be performed on data of a certain cluster. In addition, in the present exemplary embodiment, a neutral network algorithm may be utilized in the case of multi-dimensional analysis and prediction having various types of information to be inputted like target data and various types of services to be provided. Accordingly, in the present exemplary embodiment, the pattern analyzing and predicting module 300 may cluster initial data through the unsupervised learning of the machine learning when the initial data is stored in the data base 200 and may analyze and predict using patterns by using a neutral network algorithm for the clustered data to improve the relevance of services to be provided.

Although there are many kinds of algorithms that are used for the unsupervised learning, the easiest and most efficient algorithm to implement is the k-means algorithm. The k-means algorithm is an algorithm that performs clustering by using the average of clusters. The total data is divided into clusters that are arbitrarily predetermined, and central values of the clusters are arbitrarily predetermined. A distance between the arbitrarily predetermined central value and individual data is measured, and data is allocated to data including a central value closest thereto. When the data allocation is complete, an operation of re-calculating the central values per cluster and measuring the distance and allocating them to the clusters is repeated. Thereafter, when the central value changes within a predetermined permissible error or when the operation is repeated a predetermined number times, the operation is stopped to confirm the cluster. Although the k-means algorithm can perform clustering very simply and efficiently as described above, it may select a suitable machine learning algorithm depending on various requirements such as types of data and fields of services to be provided.

In the present exemplary embodiment, a service providing module 400 configured to provide services to users depending on using patterns analyzed and predicted by the pattern analyzing and predicting module 300.

For example, when a service object relates to a field which is travel and a using pattern analyzed and predicted is an active oversea travel during a certain season of the year, the service providing module 400 determines a region where there is a lot of activity and crypto currency can be easily used among oversea travel destinations, and selects some target services of the region and provides them to you.

In the present exemplary embodiment, the service providing module 400 additionally performs sensitivity analysis in order to improve relevance and satisfaction when the service to be provided to a user is determined and provided. The sensitivity analysis is a method of quantifying a plurality of evaluation data including texts for a specific object and then predicting an appropriate object through an artificial-intelligence algorithm. FIG. 2 illustrates an example of the sensitivity analysis, and data is collected by using search engines of various SNSs such as facebook, twitter, instagram, and youtube, to be processed. When data is collected by inputting a specific search word, a first check whether there was a search within a certain time (usually 24 hours) is performed. When there was a search, it returns a sensitivity analysis result stored based on a previous search result. When there was no search, it searches all SNSs and collects and processes a searched result. Thereafter, textual data is quantified through a natural language processing, that is, morphological analysis and quantification of the analyzed result. This quantified set of data is then confirmed by the neural network algorithm as an appropriate service object. Such sensitivity analysis makes it possible to grasp a customer sensitivity to a specific service among the services. When the sensitivity analysis is used with the previously analyzed usage pattern, it is possible to greatly improve the relevance of a service to be provided to a user. In addition, it is possible to more efficiently improve the relevance of the service to be provided to the user when a set of data quantified through a quantification technique for a qualitative object including a Likert scale which is evaluation information related to a comment, a phase, a clause, or a sentence for a service object by is also used in addition to such SNS data.

In the present exemplary embodiment, when data input or output is performed through an open platform that is to be provided through an API in the apparatus for analyzing a using pattern of artificial intelligence-based crypto currency and providing a service, not only user utilization of various devices but also convenience of service providers may be improved, thereby providing more efficient services. If the crypto currency is universally, widely used, the utility thereof is not high, but by securing many service providers, it is possible to widen the scope of target service and it is possible to improve the relevance of services provided to users.

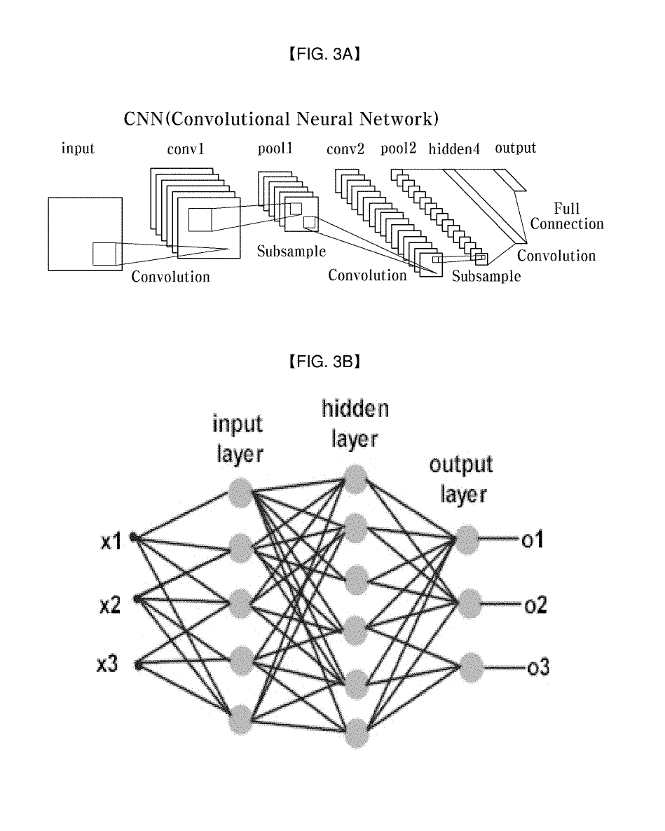

In the present exemplary embodiment, the pattern analyzing and predicting module 300 may be utilized for various fields. For example, when the pattern analyzing and predicting module 300 is used for a field of travel, services of the field of travel are arranged in a time-wise manner according to the passage of time, a favorable service to a target service is clearly distinguished according to an order of arrangement. Accordingly, when a recursive neural network which distinguishes well temporal flow and order properties and a convolutional neural network to which mathematical filters can be applied to collectively analyze partial results are used together, it is possible to more efficiently perform using pattern analysis and prediction. FIG. 3A and FIG. 3B respectively illustrate examples of a convolutional neural network (CNN) and a recursive neural network (RNN) in an artificial-intelligence algorithm. In addition, movement is essential in the case of travel, and thus a service may be provided by assigning a weight value to data related to a usage position in using history of a user and considering a moving route of the user.

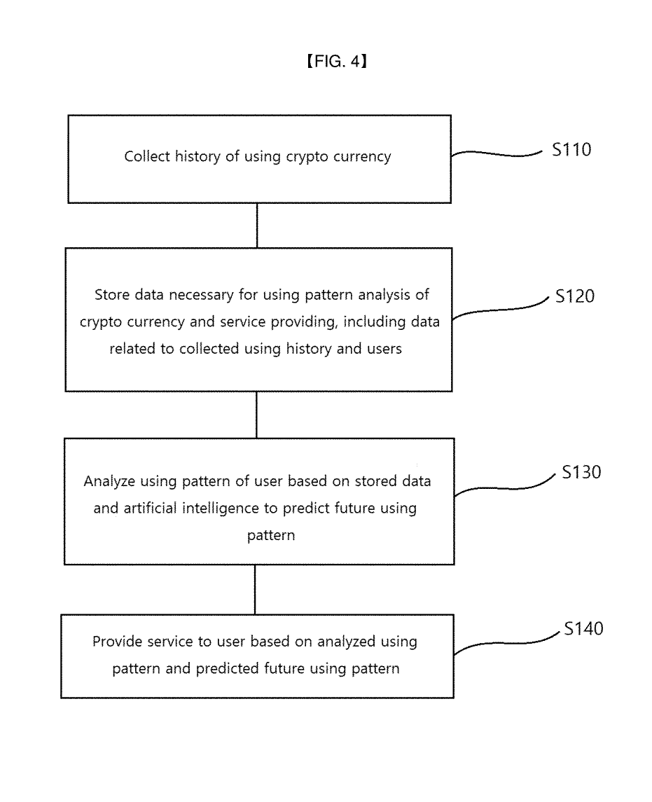

FIG. 4 is a flowchart illustrating a method for analyzing an artificial intelligence-based crypto currency using pattern and providing a service according to an exemplary embodiment of the present invention. This using pattern analyzing and service providing method will be described with reference to FIG. 4, but the same description as described above will be omitted.

In the present exemplary embodiment, the method for analyzing an artificial intelligence-based crypto currency using pattern and providing a service includes collecting history of using crypto currency by a user who owns the crypto currency (S110), storing the collected history in the data base 200 and storing data necessary for analyzing crypto currency using pattern and providing services, including data related to users who own crypto currencies and data related to services to be provided (S120), analyzing a using pattern of the user predicting a future using pattern based on the data stored in the data base 200 and artificial intelligence and (S130), and providing a best service to the user based on the analyzed using pattern and the predicted using pattern (S140).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

usage history collecting module: 100
data base: 200
pattern analyzing and predicting module: 300
service providing module: 400

What is claimed is:

1. An apparatus for analyzing a using pattern of artificial intelligence-based crypto currency and providing a service, the apparatus comprising:
a usage history collecting module configured to collect a history of using the crypto currency by a user who owns the crypto currency;
a data base configured to store data necessary for analyzing crypto currency using pattern and providing services, including data related to users who own crypto currencies, the collected using history, and data related to services to be provided;
a pattern analyzing and predicting module configured to analyze a using pattern of the user and predict a future using pattern based on the data stored in the data base and artificial intelligence; and
a service providing module configured to provide a service based on the using patterns of the user analyzed and predicted in the pattern analyzing and predicting module.

2. The apparatus of claim 1, wherein the crypto currency is a crypto currency based on a block chain technique, and
the usage history collecting module collects information necessary for using pattern analysis from usage information of the crypto currency transferred in real time based on the block chain technique.

3. The apparatus of claim 2, wherein the collected using history includes information related to a user who uses the crypto currency, an object for which the crypto currency, a time at which the crypto currency is used, and an amount of the used crypto currency, and
the pattern analyzing and predicting module matches and combines additional information of the user stored in the data base with the collected using history, and then analyzes the using pattern based on the combined data and predicts a future using pattern.

4. The apparatus of claim 3, wherein the analysis and the prediction of the using patterns based on the combined data by the pattern analyzing and predicting module is performed through an artificial-intelligence algorithm, and
the artificial-intelligence algorithm is improved by learning with the data matched and combined with the additional information stored in the data base to improve precision of the analysis and prediction of the using patterns whenever using history is added through the usage history collecting module.

5. The apparatus of claim 1, wherein the pattern analyzing and predicting module clusters the data stored in the data base through an unsupervised learning process including a k-means algorithm among machine learning, and then analyzes a using pattern of the collected using history based on the clustered data through an artificial-intelligence algorithm and predicts a future using pattern.

6. The apparatus of claim 1, wherein the service providing module determines a service object to be provided based on the using patterns analyzed and predicted in the pattern analyzing and predicting module, and
the determination of the service object is performed through a sensitivity analysis that performs analysis by quantifying SNS data related with the service object and evaluation information of the service object.

7. The apparatus of claim 6, wherein the sensitivity analysis is performed based on a set of data obtained by quantifying SNS data related to a service object which is textual data and evaluation information related to the service object through a natural language processing and a set of data quantified through evaluation for quantifying a qualitative object including Likert scale related to a specific word or clause.

8. The apparatus of claim 1, wherein data input or output is performed through an open platform that is to be provided through an API in the apparatus for analyzing a using pattern of artificial intelligence-based crypto currency and providing a service, including the usage history collecting module and the service providing module.

9. The apparatus of claim 1, wherein when a field of a service to be provided by the service providing module relates to travel, the pattern analyzing and predicting module uses an artificial-intelligence algorithm obtained by a combination of a convolutional neural network and a recursive neural network to analyze and predict a using pattern of a user.

10. The apparatus of claim 9, wherein the service providing module provides a service to a user in consideration of a moving route of the user by using data related to a usage position of the using history collected in the usage history collecting module.

11. A method for analyzing a using pattern of artificial intelligence-based crypto currency and providing a service, the method comprising:
collecting a history of using the crypto currency by a user who owns the crypto currency through a usage history collecting module;
storing the using history of the user collected whenever the using history is collected, in a data base, and pre-storing data necessary for analyzing crypto currency using pattern and providing services, including data related to users who own crypto currencies, the collected using history, and data related to services to be provided, in the data base;
analyzing a using pattern of the user and predict a future using pattern based on the data stored in the data base and artificial intelligence in a pattern analyzing and predicting module; and
providing a service to the user by a service providing module based on the using pattern of the user and the future using pattern analyzed and predicted in the analyzing of the using pattern and the predicting.

12. The method of claim 11, wherein the crypto currency is a crypto currency based on a block chain technique, and
information necessary for using pattern analysis is collected from usage information of the crypto currency transferred in real time based on the block chain technique in the collecting of the using history.

13. The method of claim 12, wherein the collected using history includes information related to a user who uses the crypto currency, an object for which the crypto currency, a time at which the crypto currency is used, and an amount of the used crypto currency,
the analyzing of the using pattern and the predicting further includes matching and combining additional information of the user stored in the data base with the collected using history, and
the using pattern is analyzed based on the combined data to predict a future using pattern.

14. The method of claim 13, wherein the analysis and the prediction of the using patterns based on the combined data is performed through an artificial-intelligence algorithm in the analyzing of the using pattern and the predicting, and
the artificial-intelligence algorithm is improved by learning with the data matched and combined with the additional information stored in the data base to improve precision of the analysis and prediction of the using patterns whenever using history is added in the collecting of the usage history.

15. The method of claim 11, wherein the analyzing of the using pattern and the predicting further includes unsupervised learning including a k-means algorithm of machine learning for the data stored in the data base, and
the data stored in the data base is clustered through the unsupervised learning, and then a using pattern of the collected using history is analyzed based on the clustered data through an artificial-intelligence algorithm to predict a future using pattern.

16. The method of claim 11, wherein the providing of the service includes determining a service object to be provided based on the using patterns analyzed and predicted in the analyzing of the using pattern and the predicting, and
the determination of the service object is performed through a sensitivity analysis that performs analysis by quantifying SNS data related with the service object and evaluation information of the service object.

17. The method of claim 16, wherein the sensitivity analysis is performed based on a set of data obtained by quantifying SNS data related to a service object which is textual data and evaluation information related to the service object through a natural language processing and a set of data quantified through evaluation for quantifying a qualitative object including Likert scale related to a specific word or clause.

18. The method of claim 11, wherein data input or output is performed through an open platform that is to be provided through an API in the method for analyzing a using pattern of artificial intelligence-based crypto currency and providing a service, including the collecting of the using history and the providing of the service.

19. The method of claim 11, wherein when a field of a service to be provided in the providing of the service relates to travel, an artificial-intelligence algorithm that is used in the analyzing of the using pattern and the predicting is obtained by a combination of a convolutional neural network and a recursive neural network to analyze and predict a using pattern of a user.

20. The method of claim 19, wherein the providing of the service includes providing a service to a user in consideration of a moving route of the user by using data related to a usage position of the using history collected in the collecting of the using history.
